(19) United States
(12) Patent Application Publication
(10) Pub. No.: US 2018/0373512 A1
(43) Pub. Date: Dec. 27, 2018

(54) METHOD AND DEVICE FOR SIMULATING SYNCHRONOUS BLOCKING IN ASYNCHRONOUS ENVIRONMENT, STORAGE MEDIUM, SERVER AND TERMINAL

(71) Applicant: Shanghai Muji Network Technology Co., Ltd., Shanghai (CN)

(72) Inventor: Shuang Li, Shanghai (CN)

(21) Appl. No.: 16/001,043

(22) Filed: Jun. 6, 2018

(30) Foreign Application Priority Data
Jun. 23, 2017 (CN) 201710487460.5

(51) Int. Cl. G06F 8/41

(52) U.S. Cl. CPC G06F 8/447; G06F 8/458

(57) ABSTRACT

Method and device for simulating synchronous blocking in an asynchronous environment, a storage medium, a server and a terminal are provided. The method includes: receiving converted codes from a server, wherein original codes run in a synchronous environment are converted to obtain the converted codes that are run in the asynchronous environment, and the converted codes comprise blocking detection codes; following execution of the converted codes, executing the blocking detection codes to detect whether there is a blocking; when the blocking is detected, sending a location of a blocking point to the server and saving an execution context; and after an operation corresponding to the blocking is performed, restoring the execution context and continuing executing codes after the location of the blocking point. Whether there is a blocking may be detected accurately and code execution efficiency may be improved.

### CROSS-REFERENCE TO RELATED APPLICATIONS

The present application claims priority to Chinese patent application No. 201710487460.5, filed on Jun. 23, 2017, and entitled “METHOD AND DEVICE FOR SIMULATING SYNCHRONOUS BLOCKING IN ASYNCHRONOUS ENVIRONMENT, STORAGE MEDIUM, SERVER AND TERMINAL”, and the entire disclosure of which is incorporated herein by reference.

### FIELD OF THE DISCLOSURE

The present disclosure generally relates to computer technology field, and more particularly, to method and device for simulating synchronous blocking in an asynchronous environment, a storage medium, a server and a terminal.

### BACKGROUND OF THE DISCLOSURE

When a native game for a client is ported to a web game at a terminal using compiling technology, a serious problem is that there is no synchronous blocking instruction in an execution environment at the terminal, that is, a synchronous blocking process cannot be realized at the terminal.

The terminal may include a browser, a web view component and other terminal devices that run JavaScript or WebAssembly and employ code logic of asynchronous calling functions.

Specifically, the native game employs code logic of synchronous calling functions. Due to data loading, network communication and other reasons, there may be synchronous blocking. For example, when a suspending operation, a sleeping operation or a waiting operation is performed, the native game enters a blocking status. The blocking indicates suspending a thread, maintaining a status of an execution context, and restoring the execution context after a task is completed.

However, in the execution environment at the terminal, code logic of asynchronous calling functions is employed. When blocking occurs, a status of the execution context cannot be maintained. Instead, the execution context is cleaned up, and execution codes of the terminal are waken up through status, notification and callback after a task is completed. The terminal creates a new execution context rather than restoring the previous execution context. Therefore, in the execution environment at the terminal, it is impossible to implement code logic same as the native game.

In existing techniques, locations of blocking points in the native game are pre-judged manually, code fragments are further configured between adjacent blocking points, and a parameter value of a previous code fragment before the blocking point is manually assigned to a parameter of the execution context in the latter code fragment after the blocking point, to simulate a synchronous blocking process in the native game.

However, the above method relies on manual pre-judgment of the locations of the blocking points, which may be inaccurate. Besides, if the number of pre-judged blocking points is too great, high cost of manual code refactoring and low efficiency may be resulted; if the number of the pre-judged blocking points is too small, the execution context before the blocking points and after the blocking points may be inconsistent when blocking occurs, and even a program may be interrupted.

Further, in the existing techniques, to accurately judge the locations of the blocking points, codes need to be refactored manually. That is, the parameter value of the previous code fragment before the blocking point is assigned to the parameter of the execution context in the latter code fragment after the blocking point, which causes high manual cost.

### SUMMARY

In embodiments of the present disclosure, method and device for simulating synchronous blocking in an asynchronous environment, a storage medium, a server and a terminal are provided. Whether there is a blocking may be detected accurately and code execution efficiency may be improved.

In an embodiment of the present disclosure, a method for simulating synchronous blocking in an asynchronous environment is provided, including: receiving converted codes from a server, where original codes run in a synchronous environment are converted to obtain the converted codes that are run in the asynchronous environment, and the converted codes include blocking detection codes; following execution of the converted codes, executing the blocking detection codes to detect whether there is a blocking; when the blocking is detected, sending a location of a blocking point to the server and saving an execution context; and after an operation corresponding to the blocking is performed, restoring the execution context and continuing executing codes after the location of the blocking point.

Optionally, saving an execution context may include: executing context saving codes to save the execution context of the original codes, where the context saving codes are obtained from the server.

Optionally, the context saving codes may be inserted in the converted codes.

Optionally, restoring the execution context and continuing executing codes after the location of the blocking point may include: receiving from the server a code fragment which includes codes after the location of the blocking point in the converted codes; executing context restoring codes to restore the execution context of the original codes, where the context restoring codes are obtained from the server; and executing the code fragment.

Optionally, the context restoring codes may be inserted in the code fragment.

Optionally, the code fragment may be created by a compiler.

In an embodiment of the present disclosure, a method for simulating synchronous blocking in an asynchronous environment is provided, including: converting original codes run in a synchronous environment into converted codes that are run in the asynchronous environment, and inserting blocking detection codes in the converted codes; sending the converted codes to a terminal, so that the terminal executes the converted codes and executes the blocking detection codes to detect whether there is a blocking; receiving a location of a blocking point from the terminal, where the location of the blocking point is sent when the blocking is detected by the terminal; and sending to the terminal a code fragment, so that the terminal continues executing codes after the location of the blocking point following performing an operation corresponding to the blocking.

Optionally, the method may further include: sending context saving codes to the terminal, so that the terminal saves the execution context of the original codes; and sending context restoring codes to the terminal, so that the terminal restores the execution context following performing an operation corresponding to the blocking.

Optionally, the context saving codes may be inserted in the converted codes.

Optionally, the context restoring codes may be inserted in the code fragment.

Optionally, sending to the terminal a code fragment may include: creating a code fragment based on the location of the blocking point, where the code fragment includes codes after the location of the blocking point in the converted codes; and sending to the terminal the code fragment.

Optionally, the code fragment may be created by a compiler.

In an embodiment of the present disclosure, a device for simulating synchronous blocking in an asynchronous environment is provided, including: a converted code receiving circuitry, configured to receive converted codes from a server, where original codes run in a synchronous environment are converted to obtain the converted codes that are run in the asynchronous environment, and the converted codes include blocking detection codes; a blocking detecting circuitry, configured to: following execution of the converted codes, execute the blocking detection codes to detect whether there is a blocking; a context saving circuitry, configured to: when the blocking is detected, send a location of a blocking point to the server and save an execution context; and a context restoring circuitry, configured to: after an operation corresponding to the blocking is performed, restore the execution context and continue executing codes after the location of the blocking point.

In an embodiment of the present disclosure, a device for simulating synchronous blocking in an asynchronous environment is provided, including: a code converting circuitry, configured to convert original codes run in a synchronous environment into converted codes that are run in the asynchronous environment, and insert blocking detection codes in the converted codes; a converted code sending circuitry, configured to send the converted codes to a terminal, so that the terminal executes the converted codes and executes the blocking detection codes to detect whether there is a blocking; a blocking point location receiving circuitry, configured to receive a location of a blocking point from the terminal, where the location of the blocking point is sent when the blocking is detected by the terminal; and a code fragment sending circuitry, configured to send to the terminal a code fragment, so that the terminal continues executing codes after the location of the blocking point following performing an operation corresponding to the blocking.

In an embodiment of the present disclosure, a computer readable storage medium which has computer instructions stored therein is provided. Once the computer instructions are executed, the above method is performed.

In an embodiment of the present disclosure, a computer readable storage medium which has computer instructions stored therein is provided. Once the computer instructions are executed, the above method is performed.

In an embodiment of the present disclosure, a terminal including a memory and a processor is provided. The memory has computer instructions stored therein, and once executing the computer instructions, the processor performs the above method.

In an embodiment of the present disclosure, a server including a memory and a processor is provided. The memory has computer instructions stored therein, and once executing the computer instructions, the processor performs the above method.

Embodiments of the present disclosure may have following advantages.

Converted codes are received from a server, where original codes run in a synchronous environment are converted to obtain the converted codes that are run in the asynchronous environment, and the converted codes include blocking detection codes. Following execution of the converted codes, the blocking detection codes are executed to detect whether there is a blocking. When the blocking is detected, a location of a blocking point is sent to the server and an execution context is saved. After an operation corresponding to the blocking is performed, the execution context is restored and codes after the location of the blocking point are continued to be executed. In the embodiments, the blocking detection codes are created at the server, and executed at the terminal to detect whether there is a blocking. Compared with the existing techniques where locations of blocking points are pre-judged manually, embodiments of the present disclosure may accurately detect whether there is a blocking, so that efficiency and robustness of code running may be effectively improved. Besides, context saving codes and context restoring codes are created at the server and executed at the terminal, to save the execution context of the original codes and restore the execution context after the operation corresponding to the blocking is performed. Compared with the existing techniques where the parameter value of the previous code fragment before the blocking point is manually assigned to the parameter of the execution context in the latter code fragment after the blocking point, embodiments of the present disclosure may effectively reduce manual cost and improve efficiency.

Further, in embodiments of the present disclosure, a code fragment is created based on the location of the blocking point at the server. Compared with the existing techniques where code fragments are configured between adjacent blocking points, embodiments of the present disclosure may effectively reduce manual cost and improve efficiency.

### BRIEF DESCRIPTION OF THE DRAWINGS

FIG. 1 schematically illustrates a flow chart of a method for simulating synchronous blocking in an asynchronous environment according to an embodiment of the disclosure;

FIG. 2 schematically illustrates a flow chart of S14 in the method shown in FIG. 1 according to an embodiment of the disclosure;

FIG. 3 schematically illustrates a data flow chart of a method for simulating synchronous blocking in asynchronous environment according to an embodiment of the disclosure;

FIG. 4 schematically illustrates a flow chart of a method for simulating synchronous blocking in an asynchronous environment according to an embodiment of the disclosure;

FIG. 5 schematically illustrates a flow chart of partial steps in a method for simulating synchronous blocking in an asynchronous environment according to an embodiment of the disclosure;

FIG. 6 schematically illustrates a data flow chart of a method for simulating synchronous blocking in an asynchronous environment according to an embodiment of the disclosure;

FIG. 7 schematically illustrates a structural diagram of a device for simulating synchronous blocking in an asynchronous environment according to an embodiment of the disclosure;

FIG. 8 schematically illustrates a structural diagram of a context restoring circuitry 74 in FIG. 7 according to an embodiment of the disclosure;

FIG. 9 schematically illustrates a structural diagram of a device for simulating synchronous blocking in an asynchronous environment according to an embodiment of the disclosure; and

FIG. 10 schematically illustrates a structural diagram of a code fragment sending circuitry 94 in FIG. 9 according to an embodiment of the disclosure.

### DETAILED DESCRIPTION OF THE DISCLOSURE

In some cases, it is necessary to simulate execution of synchronous blocking codes in an asynchronous environment. For example, when a native game for a client is ported to a web game at a terminal using compiling technology, it is desired that developed game codes can automatically become codes (such as JavaScript or WebAssembly) that can be run on a web. A critical issue is how to simulate synchronous blocking in an execution environment at the terminal.

In the asynchronous environment, data is loaded from an external environment, such as a network or a database, through asynchronous operations. Specifically, a current execution stack is unwound, an execution context is cleaned, and a callback function is invoked and a new execution context is created after asynchronous loading operations end. However, for the developed game codes, i.e., original codes, data is loaded through synchronous operations.

More specifically, in a synchronous mode, after a function call is issued, the call is not returned until a result is obtained. Take two threads A and B as an example. When the thread A is executed to a particular location, if subsequent code logic relies on the thread B, the thread A needs to wait until the thread B returns an execution result. For example, the thread A needs to implement a function that a picture is displayed on a screen. However, the picture needs to be loaded from a file system via the thread B. Therefore, the thread A should enter a blocking status. After the thread B reads the picture to a memory, the thread A can restore from the blocking status to display the picture. Blocking means that a thread needs to be suspended to maintain an execution context until a function restored from the blocking status is performed.

However, in an asynchronous mode, when a function call is issued, a caller does not immediately get a result, and a component that actually handles the call notifies the caller when the function is completed. The way to notify the caller may include statuses, notifications, callback functions and so on.

Still take the threads A and B as an example, and in the example, the caller is notified by a callback function. When the thread A needs to implement a function that a picture is displayed on a screen, and the picture needs to be loaded from a file system via the thread B, an execution context of the thread A is not saved after the thread B is activated, and instead, the callback function C is registered. When the thread B returns a result of the loading and the callback function C, the callback function C has a new execution context as if running in a new thread C, as an execution context of the thread A no longer exists. It should be noted that the thread C cannot automatically inherit the execution context of the thread A, and necessary contextual information in the thread A needs to be delivered to the thread C by, for example, assigning values to variables.

An execution context is used to indicate a data set of an operating status of a thread at a particular point, and may include information such as call stack and register data.

In one existing solution, all external data is loaded into a memory through asynchronous operations before codes are activated, and then the data is read from the memory, which is equivalent to turning the asynchronous operations of loading the external data into synchronous operations of loading memory data. For example, WebAssembly or asm.js adopt this solution.

In particular, reading a file from a file system is considered as a blocking operation in C or C++ native codes. When the file system is simulated in the memory, the blocking operation may be changed to a non-blocking operation by converting reading a disk file externally into reading memory data internally. More specifically, reading the disk file as an external I/O operation is relatively slow and requires waiting of the CPU, thus, it can be considered as an blocking operation. Reading memory data as a CPU internal operation is relatively fast, thus, it can be considered as a non-blocking operation.

However, the solution has a strict requirement on storage capacity of the memory. In particular, the external data is always large in size, and preloading requires occupying a large storage space in the memory. However, a terminal generally has limited memory space which is easily occupied. In serious situations, a crash of the terminal may be caused. With improvement of technologies and increase of user experience demands, external resources and data files will become more and more, which makes the problem more and more serious in the solution.

In another existing solution, a Generator function in JavaScript is used to simulate a second thread to implement, in an asynchronous environment, suspending running and continuing running from a suspended position when it is restarted. However, in the solution, a user equipment is required to support ES6 and higher versions of JavaScript, and a compiler is difficult to optimize and has low efficiency and a low running speed.

In another existing solution, locations of blocking points in the native game are pre-judged manually, code fragments are further configured between adjacent blocking points, and a parameter value of a previous code fragment before the blocking point is assigned to a parameter of the execution context in the latter code fragment after the blocking point, to simulate a synchronous blocking process in the native game. However, the above method relies on manual pre-judgment of the locations of the blocking points and manual value assignment for execution context. Therefore, the above method may be costly and have low accuracy in pre-judgment of the locations of the blocking points.

In embodiments of present disclosure, converted codes are received from a server, where original codes run in a synchronous environment are converted to obtain the converted codes that are run in the asynchronous environment, and the converted codes include blocking detection codes. Following execution of the converted codes, the blocking detection codes are executed to detect whether there is a blocking. When the blocking is detected, a location of a blocking point is sent to the server and an execution context is saved. After an operation corresponding to the blocking is performed, the execution context is restored and codes after the location of the blocking point are continued to be executed. In the embodiments, the blocking detection codes are created at the server, and executed at the terminal to detect whether there is a blocking. Compared with the existing techniques where locations of blocking points are pre-judged manually, embodiments of the present disclosure may accurately detect whether there is a blocking, so that efficiency and robustness of code running may be effectively improved. Besides, context saving codes and context restoring codes are created at the server and executed at the terminal, to save the execution context of the original codes and restore the execution context after the operation corresponding to the blocking is performed. Compared with the existing techniques where the parameter value of the previous code fragment before the blocking point is manually assigned to the parameter of the execution context in the latter code fragment after the blocking point, embodiments of the present disclosure may effectively reduce manual cost and improve efficiency.

In order to clarify the objects, characteristics and advantages of the disclosure, embodiments of present disclosure will be described in detail in conjunction with accompanying drawings.

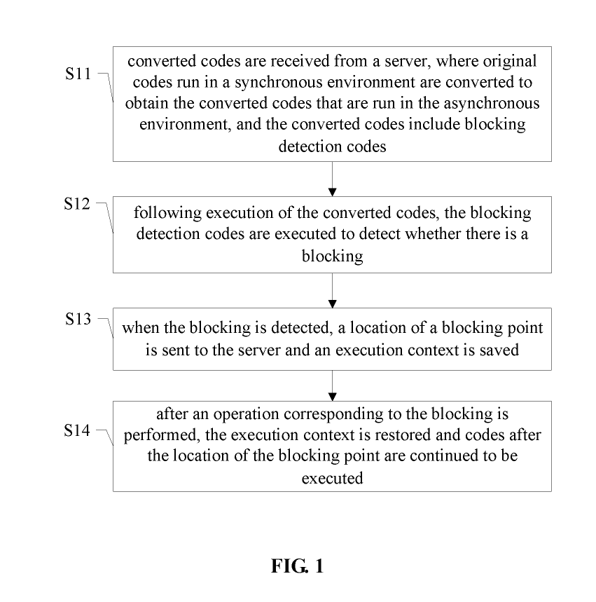

FIG. 1 schematically illustrates a flow chart of a method for simulating synchronous blocking in an asynchronous environment according to an embodiment of the disclosure. The method may be applied in a terminal and includes S11 to S14.

In S11, converted codes are received from a server, where original codes run in a synchronous environment are converted to obtain the converted codes that are run in the asynchronous environment, and the converted codes include blocking detection codes.

In S12, following execution of the converted codes, the blocking detection codes are executed to detect whether there is a blocking.

In S13, when the blocking is detected, a location of a blocking point is sent to the server and an execution context is saved.

In S14, after an operation corresponding to the blocking is performed, the execution context is restored and codes after the location of the blocking point are continued to be executed.

Regarding S11, in some embodiments, the server converts the original codes run in the synchronous environment into converted codes that are run in the asynchronous environment, and sends the converted codes to the terminal.

The converted codes may include blocking detection codes for detecting whether there is a blocking, which may save signaling overhead and improve transmission efficiency. In some embodiments, the blocking detection codes may be sent to the terminal independently.

In some embodiments, the original codes may be created by C or C++ language, or run in the synchronous environment and created by other languages. The converted codes may be created by JavaScript, or run in the asynchronous environment and created by other languages.

Regarding S12, in some embodiments, after executing the converted codes, the terminal executes the blocking detection codes to detect whether there is a blocking. The terminal may execute the blocking detection codes continuously to avoid omitting any blocking.

Regarding S13, in some embodiments, when the blocking is detected, the location of the blocking point is sent to the server and the execution context is saved.

When the blocking is detected, the location of the blocking point may be sent to the server before or after the execution context is saved. That is, an order of sending the location of the blocking point and saving the execution context is not limited in embodiments of the present disclosure.

The location of the blocking point is an address where a blocking occurs in the converted codes. The blocking may occur when an external data instruction or a waiting instruction with a predetermined time period is read.

In some embodiments, saving an execution context may include: executing context saving codes to save the execution context of the original codes, where the context saving codes are obtained from the server.

In some embodiments, the execution context of the converted codes is saved before the blocking occurs to obtain an execution context status which may be considered as an execution context status of the original codes.

In some embodiments, the context saving codes may be inserted in the converted codes and sent along with the converted codes to the terminal by the server. In some embodiments, the context saving codes may be sent independently to the terminal by the server. It should be noted that, the server should send the context saving codes beyond a time when a synchronous blocking occurs, to avoid a failure in transmission caused by the blocking. By embodiments of the present disclosure, code transmission and reception may be configured flexibly, which improves transmission efficiency.

Regarding S14, in some embodiments, after the terminal saves the execution context, an operation corresponding to the blocking is performed, such as reading external data or waiting a predetermined time period. After the operation corresponding to the blocking is performed, the saved execution context is restored, and codes after the location of the blocking point are continued to be executed.

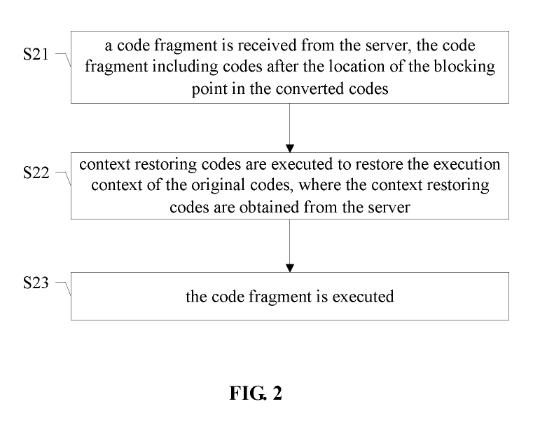

FIG. 2 schematically illustrates a flow chart of S14 in the method shown in FIG. 1 according to an embodiment of the disclosure. Restoring the execution context and continuing executing codes after the location of the blocking point may include S21 to S23.

In S21, a code fragment is received from the server, the code fragment including codes after the location of the blocking point in the converted codes.

In some embodiments, the code fragment may be created by the server.

It could be understood that, once a blocking occurs, a code fragment may be created for codes after a location of the blocking. The more the blocking points are, the larger the created code fragment is, and the higher the work load is. Compared with the existing techniques where code fragments are created manually, creating the code fragment by the server may be lower in cost and higher in efficiency.

In some embodiments, the code fragment may be created by a compiler in the server, such as a Just-In-Time Compiler (JIT) compiler.

The JIT compiler may convert codes to be converted into target codes which enable highest execution efficiency for a target platform, according to property of the target platform. The property of the target platform may include a JavaScript language version of the terminal, whether WebAssembly being supported or the like.

In S22, context restoring codes are executed to restore the execution context of the original codes, where the context restoring codes are obtained from the server.

In some embodiments, the context restoring codes may be inserted in the code fragment and sent along with the code fragment to the terminal by the server, or pre-stored in the terminal, which may save signaling overhead and improve transmission efficiency.

In S23, the code fragment is executed.

In some embodiments, the terminal may execute the code fragment to continue executing codes after the location of the blocking point.

In the embodiments, the blocking detection codes are created at the server, and executed at the terminal to detect whether there is a blocking. Compared with the existing techniques where locations of blocking points are pre-judged manually, embodiments of the present disclosure may accurately detect whether there is a blocking, so that efficiency and robustness of code running may be effectively improved. Besides, context saving codes and context restoring codes are created at the server and executed at the terminal, to save the execution context of the original codes and restore the execution context after the operation corresponding to the blocking is performed. Compared with the existing techniques where the parameter value of the previous code fragment before the blocking point is manually assigned to the parameter of the execution context in the latter code fragment after the blocking point, embodiments of the present disclosure may effectively reduce manual cost and improve efficiency.

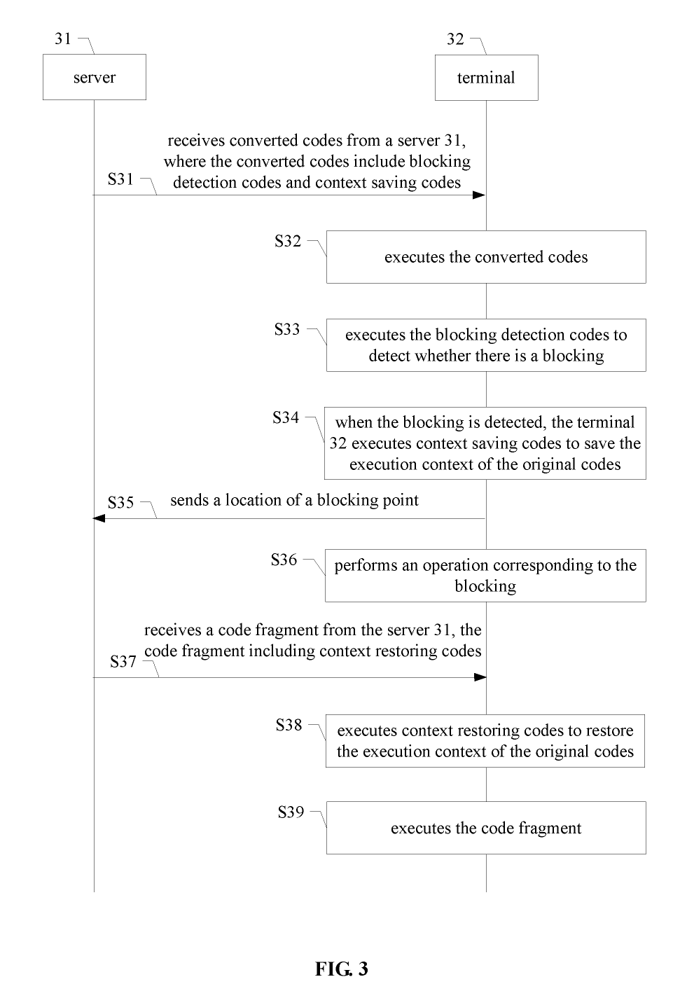

FIG. 3 schematically illustrates a data flow chart of a method for simulating synchronous blocking in asynchronous environment according to an embodiment of the disclosure. The method may be applied in a terminal and includes S31 to S39.

In S31, a terminal 32 receives converted codes from a server 31, where the converted codes include blocking detection codes and context saving codes.

In S32, the terminal 32 executes the converted codes.

In S33, the terminal 32 executes the blocking detection codes to detect whether there is a blocking.

In S34, when the blocking is detected, the terminal 32 executes context saving codes to save the execution context of the original codes.

In S35, the terminal 32 sends a location of a blocking point to the server 31.

In S36, the terminal 32 performs an operation corresponding to the blocking.

In some embodiments, the terminal 32 may send the location of the blocking point to the server 31 immediately after the blocking is detected, or during or after executing context saving codes, or during or after executing the operation corresponding to the blocking. It could be understood that, sending the location of the blocking point earlier may enable the server 31 to create the code fragment earlier, so that a time period of the terminal 32 waiting for the code fragment may be shortened or avoided, and efficiency is further improved.

In S37, the terminal 32 receives a code fragment from the server 31, the code fragment including context restoring codes.

In S38, the terminal 32 executes context restoring codes to restore the execution context of the original codes.

In some embodiments, before executing the context restoring codes in the code fragment, the terminal 32 may exit the converted codes. In a single threading environment (such as JavaScript), if the terminal does not exit the converted codes, the terminal cannot execute the code fragment.

In some embodiments, prior to exiting the converted codes, the terminal 32 may register a callback function. After the operation corresponding to the blocking is performed, the callback function is activated to trigger steps related to the code fragment. Specifically, if the callback function is to be activated, and the code fragment has been received from the server 31, the callback function may be activated to trigger the execution of steps related to the code fragment. If the callback function is to be activated, and the code fragment hasn't been received from the server 31, the callback function may be activated to trigger a step of requesting the code fragment from the server 31.

In S39, the terminal 32 executes the code fragment.

It could be understood that, when the terminal 32 executes the code fragment, the blocking detection codes can still be executed to detect whether there is a blocking. Once a blocking is detected, the execution context of the original codes may be saved and restored.

More details about the method shown in FIG. 3 can be found in the above descriptions of the methods shown in FIGS. 1 and 2, and are not described in detail here.

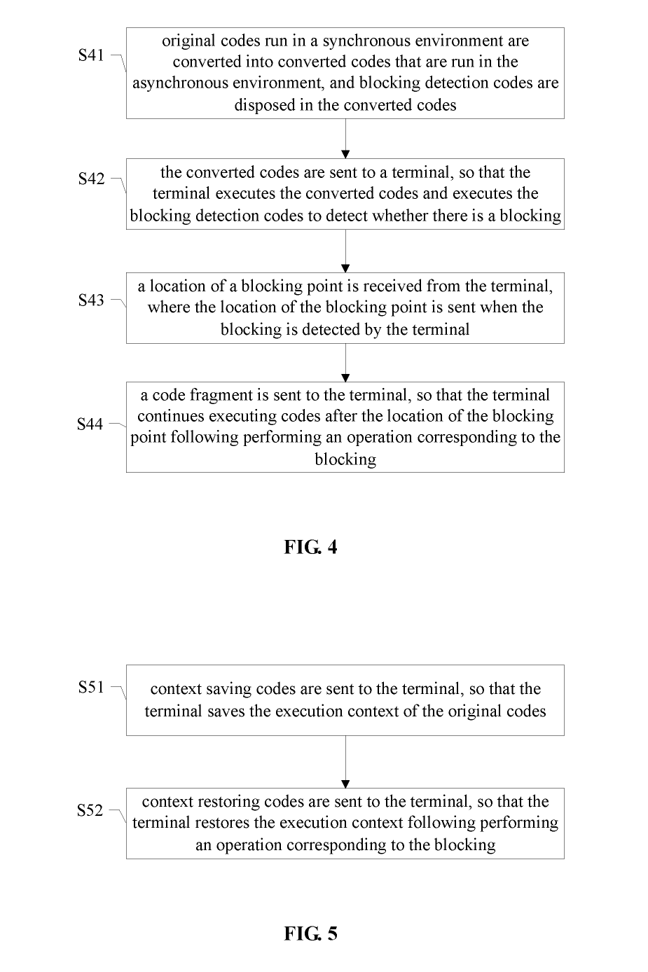

FIG. 4 schematically illustrates a flow chart of a method for simulating synchronous blocking in an asynchronous environment according to an embodiment of the disclosure. The method may be applied in a server, and includes S41 to S44.

In S41, original codes run in a synchronous environment are converted into converted codes that are run in the asynchronous environment, and blocking detection codes are inserted in the converted codes.

In S42, the converted codes are sent to a terminal, so that the terminal executes the converted codes and executes the blocking detection codes to detect whether there is a blocking.

In S43, a location of a blocking point is received from the terminal, where the location of the blocking point is sent when the blocking is detected by the terminal.

In S44, a code fragment is sent to the terminal, so that the terminal continues executing codes after the location of the blocking point following performing an operation corresponding to the blocking.

Regarding S41, in some embodiments, the server converts the original codes run in the synchronous environment into converted codes that are run in the asynchronous environment, and creates the blocking detection codes which may be inserted in the converted codes.

Regarding S42, in some embodiments, the server sends the converted codes to a terminal.

Regarding S43, in some embodiments, the server creates the code fragment according to the location of the blocking point sent by the terminal.

Regarding S44, in some embodiments, the server sends the code fragment to the terminal, so that the terminal continues executing codes after the location of the blocking point following performing the operation corresponding to the blocking.

FIG. 5 schematically illustrates a flow chart of partial steps in a method for simulating synchronous blocking in an asynchronous environment according to an embodiment of the disclosure. The method may be applied in a server and includes steps shown in FIG. 4. The method may further include S51 and S52.

In S51, context saving codes are sent to the terminal, so that the terminal saves the execution context of the original codes.

In S52, context restoring codes are sent to the terminal, so that the terminal restores the execution context following performing an operation corresponding to the blocking.

Regarding S51, in some embodiments, the context saving codes may be inserted in the converted codes and sent along with the converted codes to the terminal by the server.

Regarding S52, in some embodiments, the context restoring codes may be inserted in the code fragment and sent along with the code fragment to the terminal by the server.

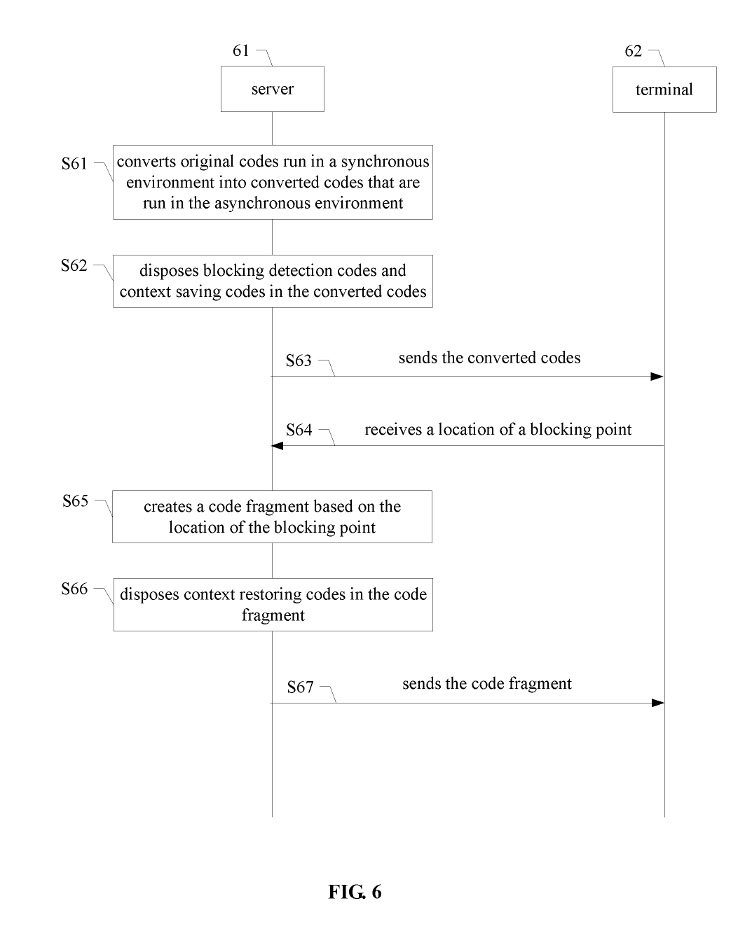

FIG. 6 schematically illustrates a data flow chart of a method for simulating synchronous blocking in an asynchronous environment according to an embodiment of the disclosure. The method may include S61 to S67.

In S61, a server 61 converts original codes run in a synchronous environment into converted codes that are run in the asynchronous environment.

In S62, the server 61 inserts blocking detection codes and context saving codes in the converted codes.

In S63, the server 61 sends the converted codes to a terminal 62.

In S64, the server 61 receives a location of a blocking point from the terminal 62.

In S65, the server 61 creates a code fragment based on the location of the blocking point.

In S66, the server 61 inserts context restoring codes in the code fragment.

In S67, the server 61 sends the code fragment to the terminal.

More details about the methods shown in FIGS. 4 to 6 can be found in the above descriptions of the methods shown in FIGS. 1 to 3, and are not described in detail here.

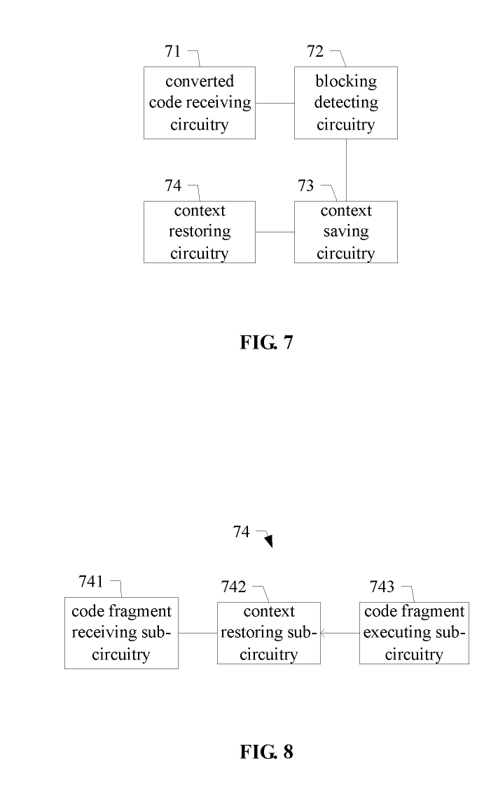

FIG. 7 schematically illustrates a structural diagram of a device for simulating synchronous blocking in an asynchronous environment according to an embodiment of the disclosure. The device may include a converted code receiving circuitry 71, a blocking detecting circuitry 72, a context saving circuitry 73 and a context restoring circuitry 74.

The converted code receiving circuitry 71 may be configured to receive converted codes from a server, where original codes run in a synchronous environment are converted to obtain the converted codes that are run in the asynchronous environment, and the converted codes include blocking detection codes. The blocking detecting circuitry 72 may be configured to: following execution of the converted codes, execute the blocking detection codes to detect whether there is a blocking. The context saving circuitry 73 may be configured to: when the blocking is detected, send a location of a blocking point to the server and save an execution context. The context restoring circuitry 74 may be configured to: after an operation corresponding to the blocking is performed, restore the execution context and continue executing codes after the location of the blocking point.

In some embodiments, the context saving circuitry 72 may include: a saving code executing sub-circuitry (not shown in FIG. 7), configured to execute context saving codes to save the execution context of the original codes, where the context saving codes are obtained from the server.

In some embodiments, the context saving codes may be inserted in the converted codes.

FIG. 8 schematically illustrates a structural diagram of the context restoring circuitry 74 in FIG. 7 according to an embodiment of the disclosure. The context restoring circuitry 74 includes a code fragment receiving sub-circuitry 741, a context restoring sub-circuitry 742 and a code fragment executing sub-circuitry 743.

The code fragment receiving sub-circuitry 741 may be configured to receive from the server a code fragment which includes codes after the location of the blocking point in the converted codes. The context restoring sub-circuitry 742 may be configured to execute context restoring codes to restore the execution context of the original codes, where the context restoring codes are obtained from the server. The code fragment executing sub-circuitry 743 may be configured to execute the code fragment.

In some embodiments, the context restoring codes may be inserted in the code fragment.

In some embodiments, the code fragment may be created by a compiler.

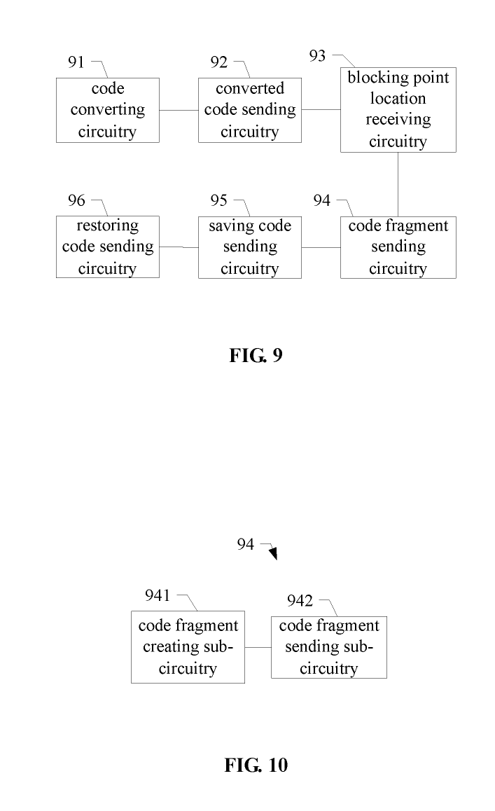

FIG. 9 schematically illustrates a structural diagram of a device for simulating synchronous blocking in an asynchronous environment according to an embodiment of the disclosure. The device may include a code converting circuitry 91, a converted code sending circuitry 92, a blocking point location receiving circuitry 93, a code fragment sending circuitry 94, a saving code sending circuitry 95 and a restoring code sending circuitry 96.

The code converting circuitry 91 may be configured to convert original codes run in a synchronous environment into converted codes that are run in the asynchronous environment, and insert blocking detection codes in the converted codes. The converted code sending circuitry 92 may be configured to send the converted codes to a terminal, so that the terminal executes the converted codes and executes the blocking detection codes to detect whether there is a blocking. The blocking point location receiving circuitry 93 may be configured to receive a location of a blocking point from the terminal, where the location of the blocking point is sent when the blocking is detected by the terminal. The code fragment sending circuitry 94 may be configured to send to the terminal a code fragment, so that the terminal continues executing codes after the location of the blocking point following performing an operation corresponding to the blocking. The saving code sending circuitry 95 may be configured to send context saving codes to the terminal, so that the terminal saves the execution context of the original codes. The restoring code sending circuitry 96 may be configured to send context restoring codes to the terminal, so that the terminal restores the execution context following performing an operation corresponding to the blocking.

In some embodiments, the context saving codes may be inserted in the converted codes.

In some embodiments, the context restoring codes may be inserted in the code fragment.

FIG. 10 schematically illustrates a structural diagram of the code fragment sending circuitry 94 in FIG. 9 according to an embodiment of the disclosure. The code fragment sending circuitry 94 may include a code fragment creating sub-circuitry 941 and a code fragment sending sub-circuitry 942.

The code fragment creating sub-circuitry 941 may be configured to create a code fragment based on the location of the blocking point, where the code fragment includes codes after the location of the blocking point in the converted codes. The code fragment sending sub-circuitry 942 may be configured to send to the terminal the code fragment.

In some embodiments, the code fragment may be created by a compiler.

More details about the devices can be found in the above descriptions of the methods shown in FIGS. 1 to 6, and are not described in detail here.

In an embodiment, a computer readable storage medium which has computer instructions stored therein is provided. Once the computer instructions are executed, the method shown in FIGS. 1 to 3 is performed. The method may be applied in a terminal. The computer readable storage medium may be an optical disk, a mechanical hard disk, a solid hard disk or the like.

In an embodiment, a computer readable storage medium which has computer instructions stored therein is provided. Once the computer instructions are executed, the method shown in FIGS. 4 to 6 is performed. The method may be applied in a server. The computer readable storage medium may be an optical disk, a mechanical hard disk, a solid hard disk or the like.

In an embodiment, a terminal including a memory and a processor is provided. The memory has computer instructions stored therein, and once executing the computer instructions, the processor performs the method shown in FIGS. 1 to 3.

In an embodiment, a server including a memory and a processor is provided. The memory has computer instructions stored therein, and once executing the computer instructions, the processor performs the method shown in FIGS. 4 to 6.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A method for simulating synchronous blocking in an asynchronous environment, comprising:
receiving converted codes from a server, wherein original codes run in a synchronous environment are converted to obtain the converted codes that are run in the asynchronous environment, and the converted codes comprise blocking detection codes;
following execution of the converted codes, executing the blocking detection codes to detect whether there is a blocking;
when the blocking is detected, sending a location of a blocking point to the server and saving an execution context; and
after an operation corresponding to the blocking is performed, restoring the execution context and continuing executing codes after the location of the blocking point.

2. The method according to claim 1, wherein saving an execution context comprises:
executing context saving codes to save the execution context of the original codes, wherein the context saving codes are obtained from the server.

3. The method according to claim 2, wherein the context saving codes are inserted in the converted codes.

4. The method according to claim 1, wherein restoring the execution context and continuing executing codes after the location of the blocking point comprises:
receiving from the server a code fragment which comprises codes after the location of the blocking point in the converted codes;
executing context restoring codes to restore the execution context of the original codes, wherein the context restoring codes are obtained from the server; and
executing the code fragment.

5. The method according to claim 4, wherein the context restoring codes are inserted in the code fragment.

6. A method for simulating synchronous blocking in an asynchronous environment, comprising:
converting original codes run in a synchronous environment into converted codes that are run in the asynchronous environment, and inserting blocking detection codes in the converted codes;
sending the converted codes to a terminal, so that the terminal executes the converted codes and executes the blocking detection codes to detect whether there is a blocking;
receiving a location of a blocking point from the terminal, wherein the location of the blocking point is sent when the blocking is detected by the terminal; and
sending to the terminal a code fragment, so that the terminal continues executing codes after the location of the blocking point following performing an operation corresponding to the blocking.

7. The method according to claim 6, further comprising:
sending context saving codes to the terminal, so that the terminal saves the execution context of the original codes; and
sending context restoring codes to the terminal, so that the terminal restores the execution context following performing an operation corresponding to the blocking.

8. The method according to claim 7, wherein the context saving codes are inserted in the converted codes.

9. The method according to claim 7, wherein the context restoring codes are inserted in the code fragment.

10. The method according to claim 6, wherein sending to the terminal a code fragment comprises:
creating a code fragment based on the location of the blocking point, wherein the code fragment comprises codes after the location of the blocking point in the converted codes; and
sending to the terminal the code fragment.

11. A device for simulating synchronous blocking in an asynchronous environment, comprising:
a converted code receiving circuitry, configured to receive converted codes from a server, wherein original codes run in a synchronous environment are converted to obtain the converted codes that are run in the asynchronous environment, and the converted codes comprise blocking detection codes;
a blocking detecting circuitry, configured to: following execution of the converted codes, execute the blocking detection codes to detect whether there is a blocking;
a context saving circuitry, configured to: when the blocking is detected, send a location of a blocking point to the server and save an execution context; and
a context restoring circuitry, configured to: after an operation corresponding to the blocking is performed, restore the execution context and continue executing codes after the location of the blocking point.

12. The device according to claim 11, wherein the context saving circuitry comprises:
a saving code executing sub-circuitry, configured to execute context saving codes to save the execution context of the original codes, wherein the context saving codes are obtained from the server.

13. The device according to claim 12, wherein the context saving codes are inserted in the converted codes.

14. The device according to claim 11, wherein the context restoring circuitry comprises:
a code fragment receiving sub-circuitry, configured to receive from the server a code fragment which comprises codes after the location of the blocking point in the converted codes;
a context restoring sub-circuitry, configured to execute context restoring codes to restore the execution context of the original codes, wherein the context restoring codes are obtained from the server; and
a code fragment executing sub-circuitry, configured to execute the code fragment.

15. The device according to claim 14, wherein the context restoring codes are inserted in the code fragment.

16. A device for simulating synchronous blocking in an asynchronous environment, comprising:
a code converting circuitry, configured to convert original codes run in a synchronous environment into converted codes that are run in the asynchronous environment, and insert blocking detection codes in the converted codes;
a converted code sending circuitry, configured to send the converted codes to a terminal, so that the terminal executes the converted codes and executes the blocking detection codes to detect whether there is a blocking;
a blocking point location receiving circuitry, configured to receive a location of a blocking point from the terminal, wherein the location of the blocking point is sent when the blocking is detected by the terminal; and
a code fragment sending circuitry, configured to send to the terminal a code fragment, so that the terminal continues executing codes after the location of the blocking point following performing an operation corresponding to the blocking.

17. The device according to claim 16, further comprising:
a saving code sending circuitry, configured to send context saving codes to the terminal, so that the terminal saves the execution context of the original codes; and
a restoring code sending circuitry, configured to send context restoring codes to the terminal, so that the terminal restores the execution context following performing an operation corresponding to the blocking.

18. The device according to claim 16, wherein the code fragment sending circuitry comprises:
a code fragment creating sub-circuitry, configured to create a code fragment based on the location of the blocking point, wherein the code fragment comprises codes after the location of the blocking point in the converted codes; and
a code fragment sending sub-circuitry, configured to send to the terminal the code fragment.

19. A computer readable storage medium which has computer instructions stored therein, wherein once the computer instructions are executed, the method according to claim 1 is performed.

20. A computer readable storage medium which has computer instructions stored therein, wherein once the computer instructions are executed, the method according to claim 7 is performed.
